(19) United States
(12) Patent Application Publication
(10) Pub. No.: US 2010/0159080 A1
(43) Pub. Date: Jun. 24, 2010

(54) Gelatin based substrate for application of oil or water soluble edible paint

(76) Inventors: Evelyn Rowland Steele, Westport, KY (US); Lida Rowland Snow, La Grange, KY (US)

Correspondence Address: David W. Carrithers;CARRITHERS LAW OFFICE, PLLC, Suite 206, 6200 Dutchmans Lane, Louisville, KY, 40205, US

(21) Appl. No.: 12/384,040

(22) Filed: Mar. 31, 2009

Related U.S. Application Data
(60) Provisional application No. 61/203,477, filed on Dec. 23, 2008.

(51) Int. Cl. A23L 1/275; A23L 1/00

(52) U.S. Cl. 426/89; 426/249

(57) ABSTRACT

A gelatin based substrate containing a milk based product and gelatin substrate mixture is poured into the mold and chilled until set forming a first gelatin and milk based substrate layer which is paintable with oil based or water based edible paint. A second layer is prepared comprising a selected second gelatin or gelatin containing flavored ingredients such as fruit or berries or combinations thereof which is spooned over the first gel and milk based substrate layer to form a bi-layer or multi-layer low calorie dessert product. The multi-layered product is chilled in the mold until set and then inverted in order to remove the mold leaving the first gel and milk based substrate as the top layer of the finished dessert product which may be painted with oil or water based edible coloring agent including an edible paint, edible dye, edible water soluble ink, and combinations thereof. The oil or water based edible paint does not bleed or dissolve in the water based gelatin and milk based substrate. The gelatin and milk based substrate can also be used to prevent bleeding or migration of colors between different colored gelatin layers.

### CROSS REFERENCE TO RELATED APPLICATIONS

This application claims priority from U.S. Provisional Application Ser. No. 61/203,477 filed on Dec. 23, 2008.

### FIELD OF THE INVENTION

A water soluble milk based product and gelatin paintable substrate is formed of a mixture of a gelatin and milk based ingredient whereby after cooling and setting, the substrate surface can be decorated with designs, drawings, and paintings, using coloring agents such as oil or water based edible dyes, inks, and paints without exhibiting bleeding or migration of the colors from the paint. The paintable substrate layer can be used to cover gelatin, fruit, or other layers of edible foodstuffs or used to prevent bleeding or migration of colors in a multi-layer gel food product.

### BACKGROUND OF THE INVENTION

The present invention relates to the preparation of gelatin based food products, and more particularly to providing a method for forming a gelatin food product having a water soluble substrate on the surface forming a layer or coating which resists bleeding or leeching of colors thereon when painted with oil or water based edible paints.

Gel based food products provide a low calorie healthy snack food or dessert such as are available in single or multiple serving portions. The food products are shelf stable or refrigerated and contain gelatin, agar, furcellaran, carrageenan, low methoxyl pectin, locust bean gum, xanthan gum, or other gelling agents. Conventional layered dessert gels having different ingredients or colors are formed by first forming a bottom gelled layer and then adding an upper layer onto the already gelled bottom layer. Because the colors are typically formed from water soluble ingredients, color migration occurs over time. It is desirable to maintain color stability in Ready to eat gel desserts which are pre-packaged and sold in single servings in retail stores; therefor, color migration can be a problem when marketing multi-colored and multi-layered gel products.

U.S. Pat. No. 5,417,990 by Soedjak et al. which issued in May 1995 teaches the use of multi layered and mutli colored gelled products using water soluble colorants and complexing agents (polyamino acids and protein materials) for colorants to prevent the colorant from migrating within the gelled layer. The crux of the '990 patent is to identify a variety of water soluble compounds such as polyamino acids, polyarginine, polylysine and polyhisidine capable of forming water soluble complexes with commonly used food colorants.

The vast majority of prior art relating to decorating pertains to confections and baked goods and the means or methods for forming three dimensional decorations and designs, usually by application of additional foodstuffs such as icing, flour, or glaze prior to applying water soluble food coloring, food dyes and the like to obtain the desired design, color and configuration. A problem occurs because these pre-cooked items are typically porous in nature and application of a water soluble paint or colorant thereto results in bleeding of the dye or paint and blurring of the design.

A method of applying edible paint to a food product is taught in U.S. Pat. No. 3,537,406 by Ort which issued in November 1970 which teaches applying designs to baked goods by silk-screening edible inks onto “half-proof” or partially risen rolls or breads. However, silk-screening permits but one color ink to be applied at a time; therefore, if it is desired to decorate a baked good with a multicolored design, several different silkscreens must be made, and a corresponding number of inking steps must be employed. Due to the amorphous nature of dough, it is difficult to insure proper registration of the several inks so that they are each in the proper places with respect to one another. The Ort reference coats the dough with flour or glycerin prior to transferring the ink to the transfer.

U.S. Pat. No. 4,560,562 by Schroeder issued in December 1985 teaches a combination of a thin sheet of marshmallow enclosed and sealed in a plastic film wherein the film is frosted to allow creative markings thereon to serve as patterns for making cutouts from the sheet which may be colored by a food coloring dye.

U.S. Pat. No. 4,285,978 by Quinlivan which issued in August 1981 teaches a decorative design formed upon baked goods by transferring a preprinted design form a transfer material to an uncooked dough surface. The dough surface is coated with a thin layer of flour or a glaze prior to applying a water soluble ink to the surface. One ink composition is water-leachable prior to baking while being water-resistant thereafter.

U.S. Patent Publication 2006/0013928 by Steet et al. published in January 2006 teaches an aqueous edible paint composition particularly useful for painting on fat-based substrates; U.S. Pat. No. 6,887,504 by Palmer et al. discloses a an apparatus for decorating food with an edible substrate using a flexible nib and U.S. Pat. No. 6,299,374 by Naor et ao. uses capillary feed to provide a marking instrument both of which are incorporated by reference herein.

U.S. Patent Publication 20060251775 by Anderson et al. published Nov. 6, 2006 discloses an solid edible paints which can be diluted with water to produce an edible watercolor based paint and is hereby incorporated by reference.

U.S. Pat. No. 4,717,571 by Okonogi et al. utilizes gelling agents having different gelling set temperatures to form patterns.

Other prior art relates to multilayered gelatin desserts but does not address the decorating aspect. One example of such prior art is U.S. Pat. No. 3,579,355-Wyss, et. al.

Although some manufactures have developed paints and dyes for oil based applications such as for application to sugar based surfaces such as icing, oils, butter based products, and oil based surfaces such as cookies and cakes, none have produced products which allow oil or water based colors to be applied to water based products such as gelatin or milk based substrates.

### SUMMARY OF THE INVENTION

Applicants' water based milk based product and gelatin substrate mixture provides an alternate to the use of the selection of soluble colorants and corresponding complexing agents to provide a low cost method of eliminating the migration of colors by separating the layers of gelatin or providing a top layer of substrate which resists migration and bleeding of even water based color paints and dyes.

One preferred embodiment of the present invention relates to the formation of multi-layered and multi-colored gelatin based food products wherein one or more layers of gelatin based food products include a top surface layer composed of a mixture comprising a gelatin and a milk based product which upon setting forms a substrate which is paintable with either oil based or water based coloring agents without migration of the colors even after an extended period of time.

Multi-component ready to eat gelatin desserts can be produced in accordance with the instant invention by mixing a first gellable liquid and milk based product ingredient forming a gelatin substrate mixture in a container such as a mold, allowing the first layer to gel or set to an extent which supports an adjacent layer; and introducing a second gellable liquid on top of the first gelled layer. The process can be repeated to form additional layers. Of course, the second or subsequent gelatin layers may contain pieces of fruit, nuts, vegetable pieces in the first or subsequent layers to produce a multi-component gelatin dessert. Each layer can have it own color, and compatible flavor such as cherry, strawberry, peach, orange, vanilla, lime, lemon, grape, etc.

The present invention provides a method for forming a paintable ornamental pattern onto a gelled dessert. For instance, a gellable liquid material can be used for the base and one or more kinds of solid materials such as pulps of fruit can be used to form a base layer having a top paintable layer formed from the mixture of the milk based ingredient and gelatin substrate.

The paint can be applied a room temperature, be applied as a flash freeze color product film and applied to the milk based product and gel substrate, or printed onto release paper, transfer paper, or wax paper for application thereto.

While a preferred embodiment will be an off white or cream colored substrate it is possible to incorporate colors therein to produce a light colored substrate serving as a base for painting with edible paints.

It is an object of the present invention to teach an improved method for forming designs upon certain food products, namely, gelatin based food products.

Another object is to provide a method whereby particular designs can be easily applied to a gelatin surface by following a simple set of instructions.

An object of this invention is to provide a method to for adhering edible paint or dye to the surface of a gelatin mold.

An object of this invention is to provide a suitable surface for adhering edible paint or dye to a gelatin product.

It is another object of the present invention to provide a means for decorating a gelatin and milk based product including evaporated milk, whipping cream, heavy cream, milk, pudding, yogurt, cream cheese, eggs, cottage cheese, sour cream and combinations thereof.

It is an object of the present invention to provide a dessert which is ideal for diners who are allergic to egg white, wheat, and grain based products.

It is an object of the present invention to provide a dessert which is ideal for diners who are concerned about fat and cholesterol.

It is an object of the present invention to provide a gelatine product producible in an unlimited variety of shapes.

Another object of this invention is to provide a gelatin surface that will not allow the food coloring or dye to run or bleed.

It is another object of the present invention to provide a gelatin and milk based product mixture which can be tinted with a color creating a pastel colored icing capable of being painted with edible paint.

Another object of the present invention is provide a process suitable for both hand and automated operation.

In accordance with the present invention, a liquid material for a base is prepared and one or more kinds of liquid material for additional layer(s) are separately prepared. The mold is prepared and the liquid base is added. Additional layers are added. After the gelatin is set, the product is removed from the mold and ready for decoration. The food coloring or food dye is applied as described herein.

More particularly, an improved method of decorating a paintable substrate formed of gelatin and milk based products with designs, drawings, and paintings, using edible dyes, inks, and paints, comprise the steps of preparing a first layer by adding hot liquid into gelatin, stirring the hot liquid and the gelatin until it is completely dissolved in the water. Additional cold water may be used to mix with the dissolved gelatin to obtain the desired concentration prior to cooling and setting of the gelatin until it is set. The gelatin is allowed to set and cool and a cold milk based product selected from the group consisting of a yogurt, a pudding, a cream cheese, and combinations thereof into the gelatin and whisking forming a smooth layer of gelatin and milk based product mixture. A mold is prepared by lightly coating the mold surface with a release agent such as a nonsticking edible cooking spray, mayonnaise, salad dressing or the like.

The milk based product and gel mixture are poured into the mold and chilled until set forming a first gelatin and milk based substrate product layer or coating. The gelatin dessert typically includes a second layer prepared by dissolving a selected second gelatin or gelatin containing flavored ingredients such as fruit or berries or combinations thereof which is spooned over the first gel and milk based product layer forming a bi-layer or multi-layer product containing a gelatin and milk based product layer in the bottom of the mold. The multi-layered product is chilled in the mold until set and then inverted in order to remove the mold leaving the multilayered product with the first gel and milk based product forming the top layer of the finished dessert which may be painted with edible paint, edible dye, edible water soluble ink, and combinations thereof. Of course the first gel and milk based product may be very thin forming a coating for an icing or frosting.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is a top view showing a decorative gelatin dessert featuring a Christmas sleigh painted onto a top layer comprising a milk based eggnog and gelatin mixture and a bottom layer consisting of a fruit flavored gelatin;

FIG. 2 shows the decorative gelatin dessert of FIG. 1 with an additional bottom layer of a different color gelatin; and

FIG. 3 shows an additional layer of a gelatin and milk based substrate disposed between different colored layers of gelatin.

### DETAILED DESCRIPTION OF PREFERRED EMBODIMENT

As set forth in U.S. Pat. No. 5,417,990 which is incorporated by reference herein, gel contain a gelled component which typically contain a water-soluble colorant. Gelled foods may be formulated containing a water soluble colorant and an agent which complexes with the colorant to product a water soluble complex which due to its size does not migrate within the gel matrix. Complexing agents deemed suitable for use include polyamino acids such as polyarginine, polylysine and polyhisidine, and protein materials which complexs the 8-anilino-1-naphtalene-sulfonic acid, such as serum albumin, egg protein, alcohol dehyrogenase and soluble fractions of wheat gluten and casinate.

The present invention relates to the formation of multi-layered and multi-colored gelatin based food products wherein one or more layers of gelatin based food products include a top and or interior layer composed of a mixture comprising a gelatin and a milk based product which upon setting forms a substrate which is paintable with either oil based or water based colors without migration of the colors even after an extended period of time. Prevention of migration of the coloring agents is due to the formation of a gelatin and milk based mixture. While conventional gel food products may be formulated with particular complexing agents to prevent migration of layers of different colors, the present invention provides an alternate means of separation comprising a substrate which is impervious to oil or water dyes and paints and conventional food colorants thereby preventing migration of the colors throughout same.

Gelatin food products can be prepared so that they are ready for decorating upon removal from the mold or gelatin mold. The mold must be prepared by lightly greasing with mayonnaise or a non stick cooking spray to prevent the product from sticking to the mold. The milk base comprises at least one or a combination of pudding, milk, sour cream, cream cheese, yogurt, together with unflavored or flavored gelatins, water, an optionally with sugar, fruit juices, and/or various flavorings. The gelatin and milk based substrate is prepared using mixtures similar to the ones described in Tables 1-5. The gelatin and milk based substrate provides not only a palatable product but also a suitable medium for applying food paint, food coloring and/or food dye. The gelatin and milk based substrate is poured into the prepared mold and chilled. Once the gelatin and milk based substrate is almost set, an additional gelatin layer or layers may be added. The mold is allowed to chill for several hours. The mold is immersed in warm water just to the rim for approximately 15 seconds. The gelatin based food product can then be removed from the mold by placing a serving dish over the mold and turning it upside down.

To decorate the gelatin based food product an aqueous or solid edible paint, coloring or dye is used to create or provide color to the top of the finished product. One edible paint is produced by AMERICOLOR, LLC. products which are used in the process described herein. The paint, coloring, or dye is applied using art paint brushes. Templates may be used and it is contemplated that in an automated process rollers, silk screening processes or spray and freeze processes may be utilized to apply decorative colors and patterns to the gelatin and milk based substrate layer.

### Method of Painting:

Typically ¼ inch flat brushes and a #4 round brush may be utilized for most applications. A paste food coloring available from manufactures such as AMERICOLOR, LLC may be used to paint the gelatin. The ¼ inch brush may be used for large area coverage using long, even strokes pressing very gently. The #4 round brush is used for smaller more detailed areas.

The paint, coloring or dye is applied using art paint brushes. For instance, a dry brush technique involves using varying stroke of full color with stokes of very light color and is achieved by blotting a paint brush with a paper towel prior to applying light shades.

Optionally, a FDA approved food coloring may be mixed with the gelatin providing a background of a particular color prior to painting an image thereon with an edible paint and brush or a fiber-tipped pen filled with FDA approved food coloring or a paint pen may be used for decoration.

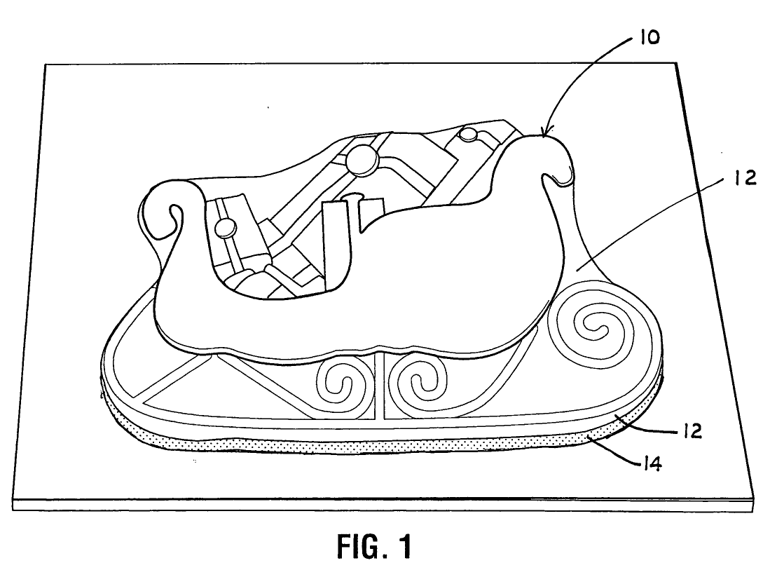

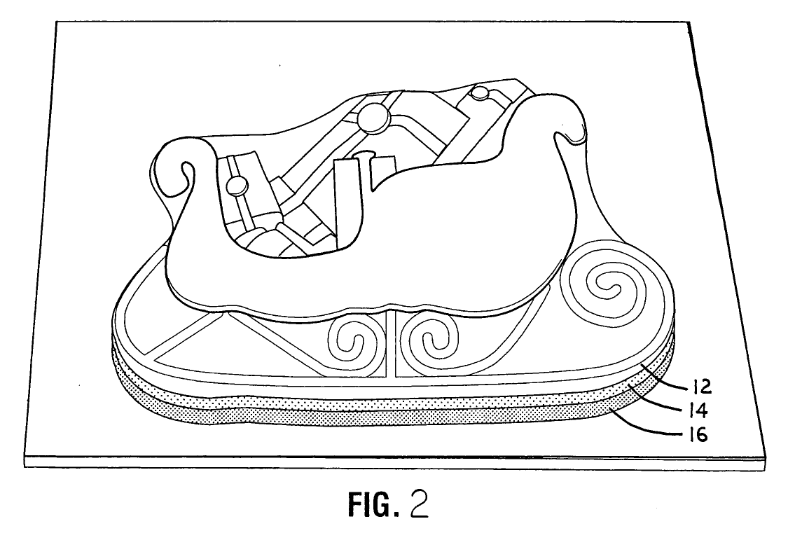

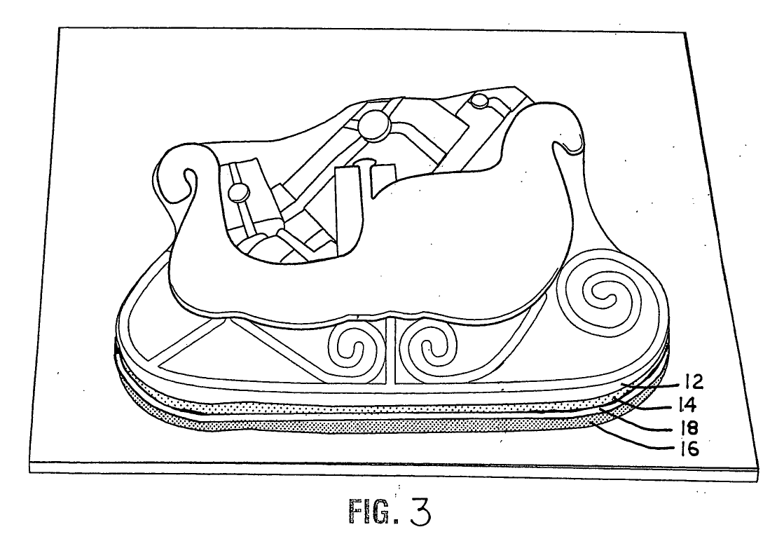

As showing in FIG. 1 a decorative gelatin dessert 10 featuring a Christmas sleigh is showing having a top paintable layer 12 comprising a milk based eggnog and gelatin mixture and a second layer 14 consisting of a fruit flavored gelatin. FIG. 2 the additional of a third layer 16 of a different color gelatin. FIG. 3 shows an additional layer of a gelatin and milk based substrate 18 disposed between different colored second layer of gelatin 14 and third layer of gelatin 16.

Food molds can be obtained from manufacturers such as CK PRODUCTS in Fort Wayne, Ind.

A list of ingredients for various gelatin and milk based substrates is as follows:

TABLE 1
Base 1

1 envelope unflavored gelatin
1 cup cold water
1 cup hot water
2 TBS. Granulated Sugar
1 Tsp. Clear Vanilla
1 8 oz. package cream cheese

TABLE 2
Base 2

1 box vanilla pudding
1 box peach gelatin
2 cups cold milk
1 cup boiling water

TABLE 3
Base 3

| | |
|---|---|
| 2 | cups heavy cream |
| ¾ | cup granulated sugar |
| 1 | envelope unflavored gelatin |
| 3 | tsp. vanilla extract |
| 1 | tsp. almond extract |
| 1½ | cups sour cream |

TABLE 4
Base 4

1 3 oz. box orange gelatin
1 cup heated orange juice
1 8 oz. plain yogurt

TABLE 5
Base 5

2 3 oz. boxes lemon gelatin
2 cups boiling water
2 tsp rum extract
2 cups chilled canned eggnog

### EXAMPLE 1

### Gelatin/Cream Cheese:

### Preparation of 1^{st} Layer:

1) Sprinkle one envelope of unflavored gelatin available from manufactures such as JELL-O-GELATIN from KRAFT FOODS, INC, in Glenview, Ill., over one cup of cold water and let stand for one minute. Add one cup of hot water and stir until dissolved forming a gelatin mixture.
2) Add sugar and vanilla to cream cheese such as PHILADELPHIA CREAM CHEESE available from KRAFT FOODS, INC, in Glenveiw, Ill., and beat for about 2 minutes or until smooth.
3) Pour gelatin mixture into the cream cheese slowly and whisk together until smooth.
4) Pour the combined mixture into a mold treated with a nonstick cooking spray or mayonnaise and tap on counter top to release any air bubbles forming a cream cheese gel mixture.
5) Chill until set.

### Preparation of Second Layer:

1) Add two 6 ounce boxes of gelatin into three cups of boiling water and stir for two minutes or until completely dissolved.
2) Add two cups of ice cubes and stirs until the gelatin is partially thickened and the ice has melted.
3) Fold in two cups of cold mashed fruit or berries.
4) Spoon over already set cream cheese gel mixture.
5) Chill until set.

### To Remove the Mold:

1) Immerse the mold in warm water (just to the rim) for 15 to 20 seconds.
2) Place the plate on top of the mold, turning the mold and plate over and lift the mold off leaving the finished product on the plate as shown in FIG. 1.

### EXAMPLE 2

### Gelatin/Pudding:

### Preparation of 1^{st} Layer:

1) Sprinkle one envelope of fruit or berry flavored gelatin over one cup of cold water and let stand for one minute. Add one cup of hot water and stir until dissolved forming a gelatin mixture.
2) Sprinkle vanilla pudding over two cups of cold milk and whisk until creamy.
3) Pour gelatin mixture into the cream cheese slowly and whisk together until smooth.
4) Pour the combined mixture into a mold treated with a nonstick cooking spray or mayonnaise and tap on counter top to release any air bubbles forming a pudding gel mixture.
5) Chill until set.

### Preparation of Second Layer:

1) Pour two cups of boiling water over a fruit or berry gelatin of boiling water and stir for two minutes or until completely dissolved.
2) Add one cup of ice cubes and stir until the gelatin is partially thickened and the ice has melted.
3) Place in refrigerator to chill for about ten minutes.
4) Fold in two cups of cold mashed fruit or berries.
4) Spoon over already set pudding gel mixture.
5) Chill until set.

### To Remove the Mold:

1) Immerse the mold in warm water (just to the rim) for 15 to 20 seconds.
2) Place the plate on top of the mold, turning the mold and plate over and lift the mold off leaving the finished product on the plate.

The foregoing detailed description is given primarily for clearness of understanding and no unnecessary limitations are to be understood therefrom, for modifications will become obvious to those skilled in the art based upon more recent disclosures and may be made without departing from the spirit of the invention and scope of the appended claims.

We claim:

1. A gelatin based substrate for application of oil or water soluble edible coloring agents, comprising:
a coloring agent selected form the group consisting of a water soluble edible dye, a water soluble edible ink, a water soluble edible paint, an oil soluble edible dye, an oil soluble edible ink, an oil soluble edible paint, and combinations thereof;
a first top layer comprising a gelatin and milk based substrate mixture;
a second bottom food layer.

2. The substrate of claim 1, wherein said milk based product is selected from the group consisting of evaporated milk, whipping cream, heavy cream, milk, pudding, yogurt, cream cheese, eggnog, cottage cheese, sour cream and combinations thereof.

3. The substrate of claim 1, further comprising a second layer prepared by dissolving a selected second gelatin or gelatin containing flavored ingredients such as fruit or berries or combinations thereof which is spooned over said first top layer forming a multi-layer product.

4. The substrate of claim 1, wherein application of said coloring agent to said substrate does not run or bleed.

5. An improved method of decorating gelatin food products comprising a coloring agent selected form the group consisting of a water soluble edible dye, a water soluble edible ink, a water soluble edible paint, an oil soluble edible dye, an oil soluble edible ink, an oil soluble edible paint, and combinations thereof, a first top layer comprising a gelatin and milk based substrate mixture; and a second bottom food layer with designs, drawings, and paintings, gelatin based substrate for application of oil or water soluble edible coloring agents, comprising the steps of:
1) Preparing a first layer comprising the steps of:
a) adding hot liquid into a gelatin powder;
b) stirring said hot liquid and gelatin until completely dissolved forma gel solution;
c) allowing said gel solution to set and cool;
d) adding a milk based product selected from the group consisting of an evaporated milk, whipping cream, heavy cream, milk, pudding, yogurt, cream cheese, eggnog, cottage cheese, sour cream and combinations thereof over said gelatin and whisking forming a smooth layer of gelatin and milk based product substrate mixture;
e) preparing a mold by lightly coating the mold surface with a nonsticking edible cooking spray;
f) pouring said gelatin and milk based product substrate mixture into a mold;
g) chilling said gelatin and milk based product substrate mixture until set forming a first gelatin and milk based product substrate layer;
2) preparing a second layer comprising the steps of:
a) dissolving a selected second gelatin in boiling after and stirring same;
b) chilling said second gelatin until set;
c) adding and fruit or flavor ingredients forming a second gel layer;
3) apply said second gelatin layer product over said gelatin and milk based product substrate milk substrate layer;
a) chilling said multi gel layer product in mold until set;
b) inverting said mold and removing said multi-gel and milk based substrate layer from said mold onto a plate; and
4) painting said gelatin and milk based product substrate layer with an edible coloring agent selected form the group consisting of a water soluble edible dye, a water soluble edible ink, a water soluble edible paint, an oil soluble edible dye, an oil soluble edible ink, an oil soluble edible paint, and combinations thereof;
